(19) United States
(12) Patent Application Publication
(10) Pub. No.: US 2021/0072968 A1
(43) Pub. Date: Mar. 11, 2021

(54) AUTOMATED PROVISIONING OF A VEHICLE PROFILE PACKAGE

(71) Applicant: Ford Global Technologies, LLC, Dearborn, MI (US)

(72) Inventor: Abraham Mezaael, Southfield, MI (US)

(73) Assignee: Ford Global Technologies, LLC, Dearborn, MI (US)

(21) Appl. No.: 16/561,716

(22) Filed: Sep. 5, 2019

(51) Int. Cl. G06F 8/65; H04L 9/32

(52) U.S. Cl. CPC G06F 8/65; G06N 5/04; H04L 9/3242

(57) ABSTRACT

Technologies are provided for the automated supply of an update for vehicle profile packages. A vehicle profile package can include a group of components, each including at least one of data or program code. The data can define a parameter of operation of a vehicle and the program code can provide one or several of a procedure to analyze the operation of the vehicle or a defined functionality of the vehicle. Some embodiments of the disclosed technologies include a computing apparatus that can determine that an update for a first vehicle profile package is available. The computing apparatus can receive a copy of an updated version of the first vehicle profile package. The computing apparatus can then lock access to the copy of the updated version of the first vehicle profile package. The computing apparatus also can provide the locked copy to a second vehicle.

### BACKGROUND

Contemporaneous vehicles provide numerous functionalities ranging from integrating multiple electronic devices into a vehicle, delivering rich entertainment, and facilitating collision avoidance and assisted maneuvering. Those functionalities, however, rely on data and program code (software applications, firmware applications, libraries, etc.) that require routine updates. Lack of maintenance can detract from the benefits of driving a vehicle that has those functionalities. Much remains to be improved in conventional technologies for provisioning updated data and/or program code for a vehicle.

### BRIEF DESCRIPTION OF THE DRAWINGS

The accompanying drawings form part of the disclosure and are incorporated into the present specification. The drawings, which are not drawn to scale, illustrate some embodiments of the disclosure. The drawings in conjunction with the description and claims serve to explain, at least in part, various principles, aspects, and practical elements of the disclosure. Some embodiments of the disclosure are described more fully below with reference to the accompanying drawings. However, various aspects and elements of the disclosure can be implemented in many different forms and should not be construed as being limited to the implementations set forth herein. Like numbers refer to like, but not necessarily the same or identical, elements throughout.

FIG. 1 illustrates an example of an operational environment to supply updated vehicular profile packages, in accordance with one or more embodiments of this disclosure.

FIG. 2 illustrates an example of a module that generates a vehicular profile package, in accordance with one or more embodiments of this disclosure.

FIG. 3A illustrates an example of a module that supplies a vehicular profile package, in accordance with one or more embodiments of this disclosure.

FIG. 3B illustrates an example of another module that supplies a vehicular profile package, in accordance with one or more embodiments of this disclosure.

FIG. 4 illustrates an example of an operational environment to supply updated vehicular profile packages to out-of-network vehicles, in accordance with one or more embodiments of this disclosure.

FIG. 5 illustrates an example of a method for supplying updated vehicular profile packages, in accordance with one or more embodiments of this disclosure.

FIG. 6 illustrates an example of a method for detecting an update for a vehicle profile package, in accordance with one or more embodiments of this disclosure.

FIG. 7 illustrates an example of a method for providing an updated vehicular profile package, in accordance with one or more embodiments of this disclosure.

FIG. 8 presents an example of an apparatus for automated configuration of provision of a product or service, in accordance with one or more embodiments of this disclosure.

FIG. 9 presents an example of a computing environment for automated configuration of provision of a product or service, in accordance with one or more embodiments of this disclosure.

### DETAILED DESCRIPTION

### Overview

The disclosure recognizes and addresses, among other technical challenges, the issue of provisioning updates for data and/or program code for vehicles. To that end, the disclosure provides technologies for the automated supply of an update for vehicle profile package. A vehicle profile package can include a group of components, each including at least one of data or program code. The data can define a parameter of operation of a vehicle and the program code can provide one or several of a procedure to analyze the operation of the vehicle or a defined functionality of the vehicle. Some embodiments of the disclosed technologies include a computing apparatus that can be integrated into a vehicle or a mobile device. The computing apparatus can detect an update for a vehicle profile package. The computing apparatus can then receive a copy of an updated version of the vehicle profile package. The computing apparatus can lock access to the copy of the updated version of the vehicle profile package. The computing apparatus also can provide the locked copy to a vehicle that is compatible with the updated version of the vehicle profile package. Providing the locked copy can result in reward data or other types of incentive data for the vehicle or mobile device that includes the computing apparatus.

While some embodiments of the disclosed technologies are illustrated with reference to a mobile device and an automobile, the disclosure is not so limited. Indeed, the principles and practical elements disclosed herein can be applied to other types of communication devices and vehicles. The communication devices can be embodied in tethered computing devices that can send and receive information (data and/or signaling) wirelessly and/or via a wireline connection. A tethered computing device can include a voice-over-internet-protocol (VoIP) telephone or a two-way communication device. In turn, such vehicles can include aircraft, boats, farm equipment, and the like.

### Illustrative Embodiments

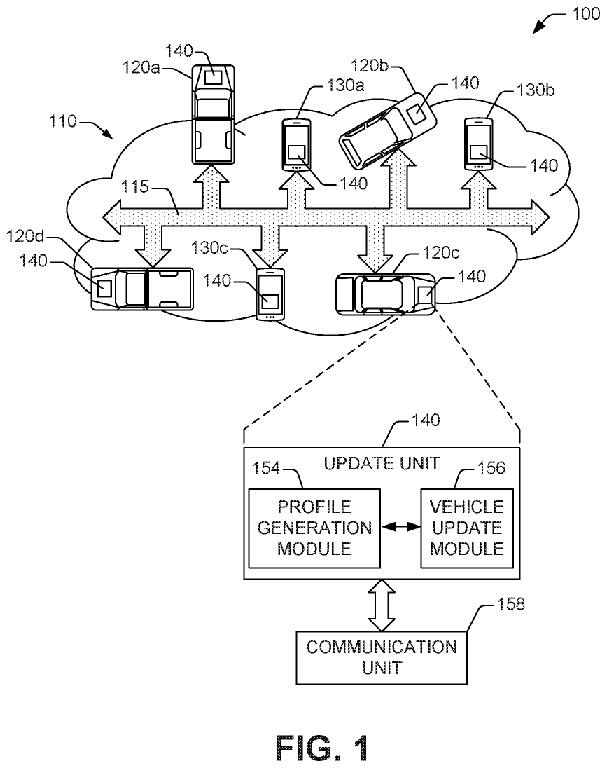

With reference to the drawings, FIG. 1 is a schematic block diagram of an example of an operational environment 100 to supply updated vehicular profile packages, in accordance with one or more embodiments of this disclosure. The exemplified operational environment 100 includes a network 110 of vehicles and mobile devices. The vehicles include driverless autonomous vehicles and/or driver-operated vehicles. In some embodiments, each one of the vehicles can be electric. In other embodiments, each one of the vehicles can rely on an internal combustion engine for locomotion. In yet other embodiments, the vehicles can include electric vehicles and other vehicles having respective internal combustion engines. The mobile devices include portable devices, each having computing resources and communication resources that permit sending, receiving, or exchanging data and/or signaling wirelessly with an external electronic device (mobile or otherwise). For instance, the mobile devices can include a mobile telephone (such as a smartphone), a tablet computer, a laptop computer, a gaming console, an electronic reader (e-reader); a consumer electronics device having wireless communication functionality; a home appliance having wireless communication functionality; a combination thereof; or similar

The network 110 also includes communication media 115 that permits exchanging data and/or signaling wirelessly between vehicles in the network 110. The communication media 115 also permits exchanging data and/or signaling between mobile devices and between vehicles and mobile devices in the network 110. The communication media 115 can include communication links, base stations, access points, and/or multiple network devices (such as server devices, gateway devices, and the like).

As is illustrated in FIG. 1, the network 100 can include a first vehicle 120a, a second vehicle 120b, a third vehicle 120c, a fourth vehicle 120d. The network 100 also can include a first mobile device 130a, a second mobile device 130b, and a third mobile device 130c. Each one of those mobile devices is represented by a smartphone simply for the sake of illustration. The communication media 115 can permit such vehicles to communicate wirelessly with one another and with such mobile devices. The communication media 115 also can permit such mobile devices to communicate with one another.

In some embodiments, each vehicle and each mobile device in the network 110 include an update unit 140 that can generate a vehicle profile package. For the sake of illustration, the vehicle profile package can include a group of components. The group of components can have a single component or multiple components. Each component in the group of components can include data or program code, or a combination of data and program code. In one example, the group of components includes proper configuration threshold for fleet excessive driving habits and/or thresholds for performance alerts (e.g., excessive RPM, harsh acceleration, harsh braking, excessive idling, and the like). In another example, the group of components includes machine learning algorithms that can be stored in vehicle data template and system. In yet another example, the group of components includes vehicle data templates and/or techniques for analyzing driver fidelity and assessing scenarios (e.g., risk assessment, such as collision risk; collision avoidance maneuvering; traffic congestion avoidance, such as generation of alternative routes; etc.). Thus, copies of respective vehicle profile packages can be traded, updated among each other. In addition, or in other embodiments, the vehicle profile package can include firmware updates, updates to software applications, a combination thereof, or similar.

Further, or in yet other embodiments, the vehicle profile package can include a module. In some embodiments, the module can be embodied in program code (compiled or source code) that provides a particular automotive functionality, such as collision avoidance; lane recognition and course preservation; blind-spot identification; and similar In other embodiments, the module can include a combination of hardware and program code. For example, the module can include a vehicle module or electronic control unit (ECU). In addition, or in some instances, each module (e.g., ECU) can be labeled or named using a unique part number that identifies (i) the module and (ii) software and hardware number. In one example, a part number that identifies a blind-spot ECU can be BL4438AC. Because part numbers can be used to indicate current software and hardware of the ECU, an ECU having part number BL4438AD may indicate newer software and part number of ECU that is compatible with other ECUs and is available for an upgrade.

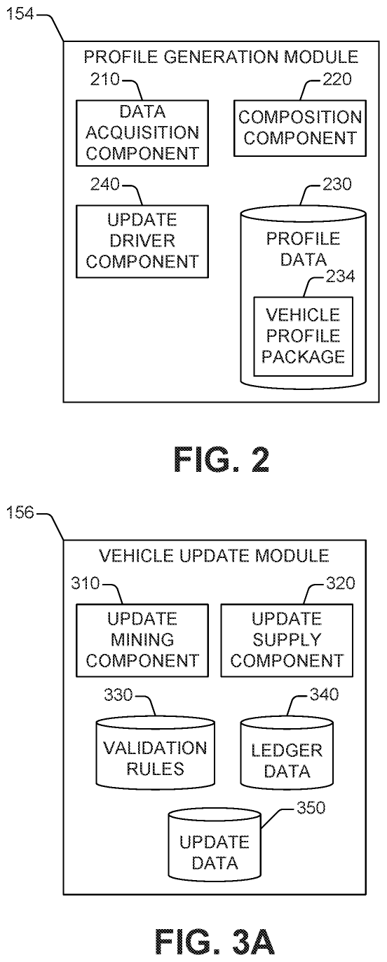

More specifically, the update unit 140 can include a profile generation module 154 that can generate the vehicle profile package. To that, the profile generation module 154 can receive performance data and/or performance metadata indicating characteristics of the operation of a vehicle. In some instances, the update unit 140 can be included in such a vehicle. For example, the update unit 140 can be included in a first vehicle of the group of vehicles 120a-120d and the profile generation module 154 can receive performance data and/or performance metadata indicating characteristics of the operation of the first vehicle. In other instances, the vehicle associated with the performance data and the performance metadata does not include the update unit 140. Thus, continuing with the preceding example, the profile generation module 154 can be included in the first vehicle and can receive performance data and/or performance metadata indicating characteristics of the operation of a second vehicle the group of vehicles 120a-120d. Regardless of the vehicle that is the source of the performance data and the performance metadata, in some embodiments, the profile generation module 154 can include a data acquisition component 210 as is shown in FIG. 2. In some instances, the data acquisition component 210 can receive the performance data and the performance metadata from sensors within the vehicle that includes the profile generation module 154. The data acquisition component 210 also can received the performance data and the performance metadata from another vehicle remotely located relative to the profile generation module 154.

With further reference to FIG. 1, the profile generation module 154 can determine a pattern of operation of a vehicle by analyzing the performance data and/or the performance metadata corresponding to the vehicle. In some configurations, the profile generation module 154 can generate a group of parameters that, individually or in a particular combination, define a satisfactory operation of the vehicle based on the pattern of operation. As an example, the group of parameters can include a first parameter that defines a threshold period for idling of the vehicle. In some embodiments, continuing with reference to FIG. 2, the profile generation module 154 can include a composition component 220 that can analyze performance data and/or performance metadata to determine such a pattern of operation and generate the group of parameters.

The group of parameters generated by the profile generation module 154 can constitute a vehicle profile package. In some embodiments, the composition component 220 (FIG. 2) can configure the group of parameters in a data structure that defines the vehicle profile package. The composition component 220 also can generate metadata defining one or many attributes of the vehicle profile package, such as version, vehicle identification number (VIN), or similar The composition component 220 can retain the data structure in one or more memory devices 230 (referred to as profile data 230), within one or more memory elements 234 (referred to as vehicle profile package 234).

The profile generation module 154 can determine if the vehicle profile package that contains the group of parameters represents an update of an extant vehicle profile package. To that, as is shown in FIG. 2, the profile generation module 154 can include an update driver component 240 in some embodiments. The update driver component 240 can determine, using the metadata that defines the attributes of the vehicle profile package, that the vehicle profile package is indeed an update to an extant vehicle profile package. Thus, the update driver component 240 can tag the vehicle profile package 234 with second metadata indicating the vehicle profile package 234 is an updated version of an extant vehicle profile package.

The update unit 140 can determine, using the second metadata, that an updated version for a vehicle profile package has been generated for the vehicle that contains the update unit 140. A vehicle update module 156 included in the update unit 140 can perform such a determination in some embodiments. In response, the update unit 140 within the vehicle can communicate an update notification message that an update for an extant vehicle profile package is available. The notification message can include, in some embodiments, update data corresponding to a portion of the updated version of the vehicle profile package. The notification message can be communicated by the vehicle update module 156, for example, by means of a communication unit 158 functionally coupled to the update unit 140.

The communication unit 158 can include one or many antennas and a communication processing device that can permit wireless communication between a vehicle and either another vehicle or an external device. The other vehicle can be, for example, one of the vehicles included in the network 110 or an out-of-network vehicle. The external device can be, for example, one of the mobile devices included in the network 110. Such a communication processing device can process data according to defined protocols of one or several radio technologies. The data that is processed can be received in a wireless signal or can be generated by the update unit 140 or another component within a vehicle that contains the communication unit 158. The radio technologies can include, for example, 3G, Long Term Evolution (LTE), LTE-Advanced, 5G, IEEE 802.11, IEEE 802.16, Bluetooth, ZigBee, near-field communication (NFC), and the like.

The update notification message can be communicated (e.g., broadcasted) to vehicles and mobile devices within the network 110 in order to detect the updated version of a vehicle profile package within the network 110. The update notification message can be received by means of respective communication units 158 present in such vehicles and mobile devices. The vehicles that receive the notification message can exclude such a vehicle. In one example, the vehicle can be the vehicle 120c, and the update unit 140 within the vehicle 120c can communicate the notification message to vehicle 120a, vehicle 120b, vehicle 120d, mobile device 130a, mobile device 130b, and mobile device 130c.

Each one of the vehicles and mobile devices that receive the update notification message can include an update unit 140 that can detect an update for a vehicle profile package within the network 110. To that end, the update unit 140 can operate on update data carried by the received notification message in order to validate the update. In one configuration, the vehicle update module 156 can operate iteratively on the update data contained in the notification message, iteratively generating validation data as a result. At each iteration, the vehicle update module 156 can then determine if the validation data generated at that iteration satisfies one or many defined validation criteria. More specifically, in one example, iteratively generating validation data includes generating a current hash value at each iteration. The hash value can be generated according to numerous types of hashing techniques, such as MD5 hashing; Secure Hash Algorithm 1 (SHA-1); Secure Hash Algorithm 2 (SHA-2) and its variants; or similar The vehicle update module 156 can then determine if a defined validation criterion is satisfied. The defined validation criterion can dictate that the current hash value must include a particular group of characters. In one example configuration, the particular group of characters can include a string of contiguous defined characters (e.g., “0000”) arranged in a particular portion of the hash value, e.g., at the beginning of the hash value or at the end of the hash value. In another example configuration, the particular group of defined characters can include a particular sequence of characters (e.g., “01AB”) where two or more of the characters in the sequence are interleaved within the current hash value. The vehicle update module 156 can continue generating validation data in response to a negative determination. In turn, in response to a positive determination, the vehicle update module 156 can determine that the update for the vehicle profile package is available. In some embodiments, as is illustrated in FIG. 2, the vehicle update module 156 can include an update mining component 310 that can operate on the updated data as is described herein. In such embodiments, the vehicle update module 156 can retain the validation criteria in one or more memory elements 330 (referred to as validation rules 330).

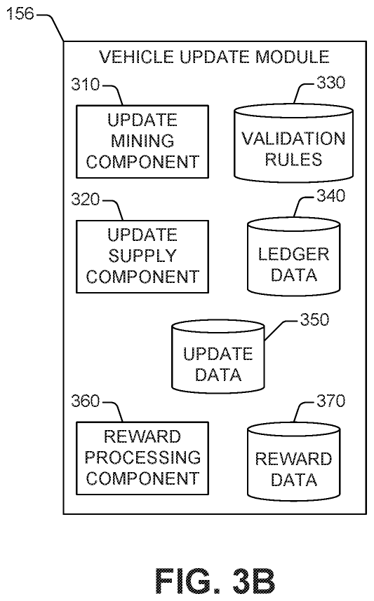

In response to the determination that the update for the vehicle profile package is available, the vehicle update module 156 can update a ledger record retained in the vehicle that includes the updated vehicle module 140. In one embodiment, the ledger record can be retained in one or many memory devices 340 (referred to as ledger data 340) as is shown in FIG. 3. The update mining component 310 (FIG. 3) can update the ledger record. The ledger record can include one or many blocks of data. Updating the ledger record can thus include, for example, adding a block of data corresponding to the update data to the ledger record.

In further response to the determination that the update for the vehicle profile package is available, the update unit 140 can cause another update unit 140 in the network 110 to update another ledger record corresponding to the other update unit 140. To that, the update unit 140 can broadcast or otherwise communicate a notification that can be received by the other update unit 140. The notification can include, for example, hash data and an instruction to add the hash data to the respective second ledger data. The hash data can include an alphanumeric string of characters or another type of hash value. In one configuration, the update unit 140 can cause each second update unit 140 in the network 110 to update respective second ledger records. For instance, the update unit 140 included in the vehicle 120c can cause each update unit 140 included respective ones of the vehicle 120a, vehicle 120b, vehicle 120d, mobile device 130a, mobile device 130b, and mobile device 130c to update respective ledger records. Thus, the update unit 140 can broadcast or otherwise communicate a notification that can be received by the update unit 140 included in each one of such vehicles and mobile devices. An update unit 140 included in a vehicle can communicate (e.g., broadcast) the notification by means of the communication unit 158. In turn, an update unit included in a mobile device can communicate (e.g., broadcast) such a notification by means of communication unit or another type of communication components integrated into the mobile device.

Updating the respective second ledger records can result in each update unit 140 having at least one common block of data representing the availability of the update for the vehicle profile package.

The vehicle update module 156 that determines that the update for a vehicle profile package is available can send a request for a copy of an updated version of the vehicle profile package. The request can be sent, for example, to a remotely located update unit 140 that generated the updated version of the vehicle profile package. In another example, the request can be sent to a network repository/device that retains the copy of the updated version of the vehicle profile package. In some embodiments, as is shown in FIG. 3, the vehicle update module 156 can include an update supply component 320 that can send a request message that the copy be sent to the update unit 140 that includes such a vehicle update module 156.

The request for the copy of an updated version of the vehicle profile package can be fulfilled and the requestor update unit 140 can receive the copy. The copy can be received in its entirety from a single source device or in multiple partitions from multiple source devices. The multiple partitions can be received during respective time intervals over a defined period of time. For instance, each partition of the multiple partitions can be received during a particular time interval throughout a 24-hour period.

The update unit 140 that receives the copy of the updated version of the vehicle profile package can lock access to the copy. The update unit 140 can retain the locked copy in in one or many memory devices 350 (referred to as updated data 350) as is shown in FIG. 3A. It is noted that the update data 350 can be specific to the vehicle that includes the vehicle update module 156 because different vehicles can supply copies of updates to different vehicle profile packages. The ledger data 340, by contrast, can be common to all vehicles that include a vehicle update module 156 in order to permit discovering an update and maintaining a record of a discovered update.

In some embodiments, the vehicle updated module 156 can lock access to the copy by means of the update supply component 320 (FIG. 2). Locking access to such a copy can include, for example, modifying the copy to generate a secured copy that can be accessed by an authorized device and/or can be accessed a single time after the copy has been distributed in accordance with aspects described herein. Accordingly, in some embodiments, locking access to the copy can include encrypting the copy using an encryption key, a token key, or another type of unique code (e.g., a secured personal identification number (PIN)). The copy can be encrypted according to numerous cryptography techniques utilizing private-public key pairs, e.g., symmetric encryption or asymmetric encryption. In one example, at least one of the private-public key pairs can include unique hash data that result from iteratively hashing update data received in an update notification corresponding to an update of the vehicle profile package until a defined validation criterion is satisfied, as is described herein. The unique hash data (e.g., an alphanumeric string of characters or another type of hash value) can be utilized only one time after the copy has been distributed. The unique hash data can define a cryptographic nonce, for example.

The update unit 140 that generates a locked copy of the updated version of a vehicle profile package can distribute the locked copy in numerous ways. In some instances, such an update unit 140 can provide the locked copy to a first vehicle. The first vehicle can be included in the network 110. The first vehicle is different from the second vehicle for which the updated vehicle profile package was generated. In some embodiments, the vehicle update module 156 can provide the locked copy by means of the update supply component 320 (FIG. 3A), using the communication unit 158.

To provide the locked copy, the vehicle update module 156 can determine a group of vehicles compatible with the updated version of the vehicle profile package. The vehicle update module 156 can utilize vehicle identification number (VIN) data to determine that a vehicle be included in group of vehicles. The VIN data can define capabilities corresponding to a VIN; features corresponding to the VIN; modules corresponding to a VIN and/or original equipment manufacturer (OEM); a combination of the foregoing; or similar The vehicle update module 156 can determine the group of vehicles by means of the update supply component 320 (FIG. 3A) in some embodiments. In one configuration, using the VIN data, the vehicle update module 156 can determine that the updated version contains logic that can be applied across the group of vehicles. For example, the vehicle update module 156 can determine that the updated version can be applied to a particular model of vehicle of a specific type (e.g., a particular light-duty truck). Thus, the vehicle update module 156 can determine one or several second vehicles of the same type (e.g., light-duty trucks) that are similar to the particular vehicle. Accordingly, the group of vehicles that is determined by the vehicle update module 156 can include the particular model of vehicle and the second vehicle(s). (e.g., ford F150 hard braking threshold is applicable on Ford F250)

In another configuration, using the VIN data, the vehicle update module 156 can determine that the updated version of the vehicle profile package contains one or more template scenario that can be applied on several vehicles. For example, such an updated version can include data representing a hard acceleration snapshot scenario on a particular model of premium high-end vehicle that collects and monitors data from camera, radar, DSRC, and/or other modules. Thus, the vehicle update module 156 can determine one or several second premium high-end vehicles for which the updated version can be applied. Accordingly, the group of vehicles that is determined by the vehicle update module 156 can include the particular model of premium vehicle and the second premium high-end vehicle(s).

In yet another configuration, the vehicle update module 156 can determine that the updated version of the vehicle profile package contains software applications and/or logic (e.g., telematics control unit (TCU), blind spot information system (BLIS), DSRC, Sync, and the like) that can be utilized by various types of vehicles. As such, the group of vehicles includes first vehicles of a first type and second vehicles of a second type, both of which types can utilize the updated version of the vehicle profile package.

In some embodiments, the vehicle update module 156 also can perform a validation assessment for each vehicle in the group of vehicles. Performing the validation assessment can result in a group of validated vehicles that are permitted to receive the locked copy of the updated version of the vehicle profile package. Specifically, performing the validation assessment can permit identifying a vehicle in a condition that may prevent the vehicle from receiving the locked copy. In some configurations, performing such a validation assessment can include comparing operational attributes of the vehicle to respective applicable thresholds levels. The operational attributes can include, for example, vehicle memory, hours of service of vehicle, compliance, battery percentage, fuel level, and the like. An operational attribute that is less than an applicable threshold level can result in the vehicle excluded from the group of vehicles. Thus, each vehicle in the group of validated vehicles include operational attributes that meet or exceed respective applicable threshold levels.

The vehicle update module 156 also can determine a satisfactory communication pathway to route a locked copy of the updated version of the vehicle profile package to one or several particular vehicles in a group of vehicles. Such a group of vehicles can be either a group of compatible vehicles or a group of validated vehicles. The vehicle update module 156 can determine the satisfactory pathway by means of the update supply component 320 (FIG. 3A) in some embodiments.

For the sake of illustration, the satisfactory communication pathway can include a specific arrangement of network devices, vehicle(s), and mobile device(s) within the network 110. The network devices can constitute the communication media 115, for example. The specific arrangement can be based on the particular vehicle to which the locked copy is routed. For example, the vehicle update module 156 can determine a first specific arrangement for a first particular vehicle (e.g., vehicle 120a) in the group of vehicles, and also can determine a second specific arrangement for a second particular vehicle (e.g., vehicle 120d) in the group of vehicles. Regardless of the particular vehicle, a satisfactory pathway can satisfy a communication cost criterion. As such, in one embodiment, the satisfactory pathway can yield a communication cost that is less than a cost threshold amount. In another embodiments, determining the satisfactory pathway can include determining a solution to an optimization problem with respect to a cost objective function. For instance, the optimization problem can be a minimization problem.

The cost objective function can be a real-valued function that depends on an amount of cellular over-the-air (OTA) communication resources for the network devices, vehicle(s), and mobile device(s) within the network 110. Specifically, the greater the amount of cellular OTA resources, the greater the magnitude of the cost objective function. Accordingly, the vehicle update module 156 configure arrangements that reduce or otherwise contain the use of cellular OTA resources. To that end, the vehicle update module 156 can utilize location data of vehicles and mobile devices within the network 110 to identify a communication pathway that increases the utilization of short-range wireless communication or non-cellular wireless communication, or a combination of both. Short-range wireless communication can include, for example, dedicated short range communications (DSRC), Bluetooth, peer-to-peer wireless communication, and similar Peer-to-peer communication can include infrared (IR) wireless communication, other dedicated vehicle-to-vehicle (V2V) communications, dedicated fleet-to-fleet (F2F) communications, file transfer applications, social media applications, or similar. Here, V2V communications can be implemented using dedicated network(s) that permit direct communication between two or more vehicles Similarly, F2F communications can be implemented using dedicated network(s) that permit directed communication between two or more vehicles of a fleet of vehicles (trucks of a van line, for example). Non-cellular wireless communication can include communication according to Wi-Fi protocols. Accordingly, in sharp contrast with conventional systems that provision an update to data and/or program code for a vehicle, the disclosed technologies can mitigate (or even eliminate, in some situations) costly cellular OTA usage or deep-space (e.g., satellite-based) wireless communication usage.

More concretely, in one example scenario, the update supply component 320 (FIG. 3A) can validate vehicle 120d to receive an updated version of a vehicle profile package. In other words, the update supply component 320 can determine that the vehicle 120d is compatible with the updated version of the vehicle profile package, and is in a condition that permits receiving a copy of the updated version. The update supply component 320 also can have access to location data that identifies a location of the vehicle 120d. In one example, the update supply component 320 can receive navigation data (e.g., global positioning system (GPS) data) from the vehicle 120d and can generate such location data using the navigation data. In another example, the update supply component 320 can receive the location data that identifies the location of the vehicle 120d from the vehicle 120d. Indeed, the supply component 320 can receive navigation data and/or location data from each one (or, in some embodiments, at least one) of the vehicles and/or mobile devices in the network 110. The update supply component 320 can then determine, using the location data, that the mobile device 130c is in a vicinity of the vehicle 120d.

The update supply component 320 also can determine that mobile device 130b is proximate to update supply component 320. To that end, the mobile device 130b can allow the update supply component 320 to access various information that can be retained in the mobile device 130b. The information can include, for example, one or many of calendar; predetermine routes (e.g., work commutes or work to home route); destination and favorite places/route; scheduled travel or trips; most frequent visited places; events; bookings; typical nearby locations; or similar Accordingly, the update supply component 320 can determine that a satisfactory communication pathway to route the copy (locked or otherwise) of the updated version of the vehicle profile package includes (i) a short-range wireless communication link between the vehicle 120c (that includes the update supply component 320) and the mobile device 130b; the mobile device 130b; (ii) a mobile-to-mobile pathway between the mobile device 130b and the mobile device 130c; (iii) the mobile device 130c; and (iv) a short-range wireless communication link between the mobile device 130b and the vehicle 120c.

The mobile-to-mobile pathway between the mobile device 130b and the mobile 130c can be a cellular network pathway within the communication media 115. The mobile-to-mobile pathway can include, in another instance, (i) a short-range wireless communication link between the mobile device 130b and the vehicle 120b; (ii) the vehicle 120b; (iii) a short-range wireless communication link between the vehicle 120b and the mobile device 130a; (iv) the mobile device 130a; and a second mobile-to-mobile pathway between the mobile device 130a and the mobile device 130c. In such an instance, the update supply component 320 can determine that the mobile device 130b is in a vicinity of the vehicle 120b and, in turn, the vehicle 120b is in a vicinity of the vehicle 120b. The second mobile-to-mobile pathway can be second cellular network pathway.

In another example scenario, the update supply component 320 can determine a common route between a first vehicle that has detected an update to a vehicle profile package and a second vehicle that has been validated to receive an updated version of the vehicle profile package. The update supply component 320 can be included in the first vehicle and has access to a locked copy of the updated version of the vehicle profile package. The update supply component 320 can determine a defined location and defined time in the common route that can permit short-range wireless communication (dedicated short range communications (DSRC), Bluetooth, or IR wireless, for example) between the first vehicle and the second vehicle. Thus, update supply component 320 can determine that a satisfactory communication pathway to send the locked copy of the updated version includes a short-range wireless communication link between the first and second vehicles at the defined location and defined time.

Regardless of the specific configuration of a satisfactory communication pathway, the vehicle update module 156 can use the satisfactory communication pathway to send a locked copy of an updated version of a vehicle profile package to particular vehicle(s) in a group of validated vehicles. In some embodiments, rather than sending a copy (locked or otherwise) of an updated version of a vehicle profile package, the vehicle update module 156 can send a recommendation message for the updated version a vehicle within the network 110. The recommendation message can be sent, in some instances, through the satisfactory pathway. The vehicle update module 156 can send the locked copy by means of the update supply component 320 (FIG. 3A), using the communication unit 158, in some embodiments.

Distributing a locked copy of the updated version of a vehicle profile package also can include, in some instances, exchanging the locked copy for a copy of an updated version of a second vehicle profile package. The update unit 140 can exchange the locked copy for such other copy with a vehicle or mobile device within the network 110. For example, the locked copy can be sent from the vehicle that includes the updated unit 140 to another vehicle in the network 110. In return, the vehicle can receive the copy of the updated version of the second vehicle profile package from the other vehicle. In some embodiments, the locked copy can be exchanged by the update supply component 320 (FIG. 3A), by means of the communication unit 158.

Distributing a locked copy of an updated version of a vehicle profile package, communicating a recommendation for an update to the vehicle profile package, and communicating an update notification that the update is available can each result in the configuration of reward data that defines a specific reward or incentive. As such, an update unit 140 that handles the distribution of the locked copy of the communication of information (recommendation or updated notification, for example) can configure the reward data. In some embodiments, as is shown in FIG. 3B, the vehicle update module 156 that can be included in the update unit 140 can include a processing reward component 360. The processing reward component 360 can receive reward data and can configure one or several records defining respective rewards available the update unit 140 that includes the vehicle updated module 156. The reward processing component 360 can retain the reward data in one or more memory devices 370 (referred to as reward data 370).

As an illustration, a mobile device in the network 110 can receive reward data (e.g., data indicative of an incentive or a free ride) from a taxi vehicle that requested a specific update. The update unit 140 that can be included in the mobile device can identify a destination and time data of the mobile device to match the taxi vehicle. Thus, the mobile device can then be able to provide the update while riding in taxi via different communication methods such as Bluetooth, Wi-Fi, or similar

More specifically, in some instances, the reward processing component 360 can receive reward data and can configure an applicable record in response to detecting an update for a vehicle profile package. In other instances, the reward processing component 360 can receive reward data and can configure an applicable record in response to obtaining a copy of an updated version of the vehicle profile package. In still other instances, the reward processing component 360 can receive reward data and can configure an applicable record in response to delivering a copy (locked or otherwise) of the updated version of a vehicle profile package to a vehicle or a mobile device. The vehicle and the mobile device can be part of the network 110.

In some embodiments, rather than a single update unit 140 distributing an entire copy of an updated version of a vehicle profile package, multiple update units 140 can distribute respective partitions of the copy to a destination vehicle, for example. Such an approach can be useful in cases where an update file is large in size. Each update unit 140 in the network 110 (whether integrated into a vehicle or mobile device) can retrieve and share one part of an update within a group of other update units 140.

Regardless the specific manner of distribution of a copy of an updated version of a vehicle profile package, the disclosed technologies can form an automated platform for provisioning a current version of a vehicle profile package. As such, vehicles of various types can be maintained up-to-date without reliance on dealership tools, for example.

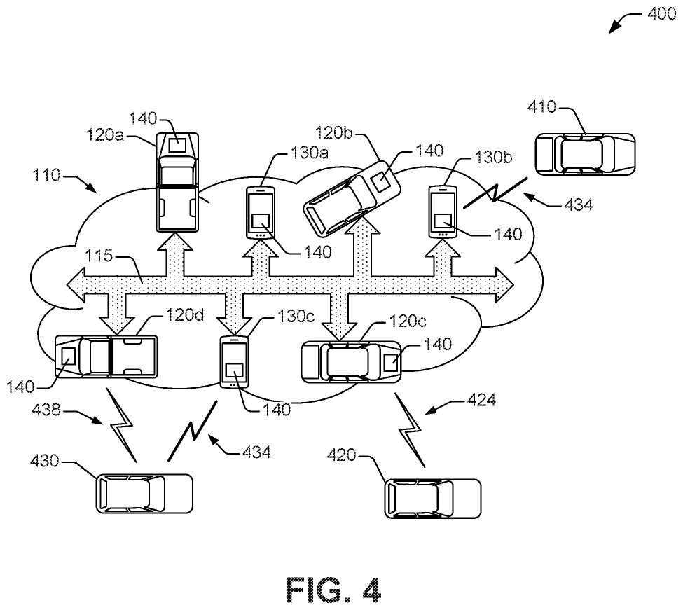

FIG. 4 is a schematic block diagram of an example of an operational environment 400 to supply updated vehicular profile packages to out-of-network vehicles, in accordance with one or more embodiments of this disclosure. Out-of-network vehicles are not part of the network 110 and do not include the update unit 140. The out-of-network vehicles, however, can include a communication unit that permits exchanging information wirelessly with a mobile device within the network 110. As is illustrated in FIG. 4, a mobile device 130b within the network 110 can be communicatively coupled with an out-of-network vehicle 410. Wireless links 434 (e.g., Bluetooth links or another type of short-range wireless communication links) can permit such a coupling between the mobile device 130b and the out-of-network vehicle 410. Thus, the mobile device 130b can access data and/or metadata available in the out-of-network vehicle 410. The mobile device 130b can have information indicating that an update for a vehicle profile package is available. As is disclosed herein, the mobile device 130b may have received an update notification from a vehicle or another mobile device in the network 110. Thus, using data and/or metadata available in the out-of-network vehicle 410, the mobile device 130b can determine that the out-of-network vehicle 410 is compatible with (and, potentially, may require) an update for a vehicle profile package.

The mobile device 130b can send an update notification to the out-of-network vehicle 410 by means of the update unit 140, using a communication unit integrated in to the mobile device 130b and wireless links 434. The update notification can be sent by means of the update unit 140, using a communication unit integrated into the mobile device. The update notification can include payload data than can cause a display device within the out-of-network vehicle 410 to present a prompt to accept the update. In some configurations, accepting the update can incur a fee or otherwise can result in a reward for the mobile device 130b. Accepting the update, however, need not incur the fee or result in a reward. In either configuration, accepting the update can cause the out-of-network vehicle 410 to send a response message requesting the update from the mobile device. The mobile device 130b can receive the response message and, in turn, can send a locked copy of an update version of the vehicle profile package.

As is also illustrated in FIG. 4, a vehicle 120c in the network 110 can have information indicating that an update for a vehicle profile package is available in some embodiments. As is disclosed herein, the vehicle 120c may have received an update notification from a vehicle or another mobile device in the network 110. The vehicle 120c can determine that the out-of-network vehicle 420 is compatible with (and may require) an update for a vehicle profile package. To that end, the vehicle 120c can be communicatively coupled with the out-of-network vehicle 420 by means of wireless links 424 (e.g., Bluetooth links or another type of short-range wireless communication links) and can access data and/or metadata available in the out-of-network vehicle 420. The vehicle 120c can then send an update notification to the out-of-network vehicle 420. The update notification can be sent by means of the update unit 140 integrated into the vehicle 120c, using the communication unit 158. The update notification can include payload data than can cause a display device within the out-of-network vehicle 420 to present a prompt to accept the update. In some configurations, accepting the update can incur a fee or otherwise can result in a reward for the vehicle 120c. Accepting the update, however, need not incur the fee or result in a reward. In either configuration, accepting the update can cause the out-of-network vehicle 420 to send a response message requesting the update from the mobile device. The vehicle 120c can receive the response message and, in turn, can send a locked copy of an update version of the vehicle profile package.

Communication also can be initiated by out-of-network vehicles, mediated by a mobile device or a vehicle that is part of the network 110 for example. As an illustration, the mobile device 130c can be proximate and external to an out-of-network vehicle 430, and can be communicatively coupled to the out-of-network vehicle 430. Wireless links 434 (e.g., Bluetooth links or another type of short-range wireless communication links) can permit such a coupling between the mobile device 130c and the out-of-network vehicle 430. Thus, the mobile device 130c can access data and/or metadata available in the out-of-network vehicle 430. The vehicle update module 156, or a component therein, can access such data. Using the accessed information, the mobile device 130c can determine that the out-of-network vehicle 430 is available to handle a copy of an updated version of a vehicle profile package. Accordingly, the mobile device 130c can communicate (e.g., broadcast) a notification that the out-of-network vehicle 430 is available to handle the copy of the updated version of a vehicle profile package. The notification can be communicated to other mobile devices and/or vehicles within the network 110, via the communication media 115. In other instances, while not depicted in FIG. 4, the mobile device 130c can be located within the out-of-network vehicle 430 and can be in communication with the out-of-network vehicle 430. In those instances, the mobile device 130c also can determine that the out-of-network vehicle is available to handle the copy of the updated version of the vehicle profile package and can communicate a notification to that end to other vehicles and/or mobile devices within the network 110. Handling such a copy can include, for example, sending the copy or exchanging the copy for a copy of an updated version of another vehicle profile package.

As another illustration, the vehicle 120d can be proximate to the out-of-network vehicle 430, and can be communicatively coupled to the out-of-network vehicle 430. Wireless links 438 (e.g., Bluetooth links or another type of short-range wireless communication links) can permit such a coupling between the vehicle 120d and the out-of-network vehicle 430. Thus, the vehicle 120d can access data and/or metadata available in the out-of-network vehicle 430. The vehicle update module 156 included in the update unit 140 can access such data, for example. Using the accessed information, the vehicle 120d can determine that the out-of-network vehicle 430 is available to handle a copy of an updated version of a vehicle profile package. Accordingly, the vehicle 120d can communicate (e.g., broadcast) a notification that the out-of-network vehicle 430 is available to handle the copy of the updated version of the vehicle profile package. The notification can be communicated to other mobile devices and/or vehicles within the network 110, via the communication media 115. As mentioned, handling such a copy can include, for example, sending the copy or exchanging the copy for a copy of an updated version of another vehicle profile package.

A vehicle and/or a mobile device within the network 110 can receive the notification that the out-of-network vehicle 430 is available to handle a copy of an updated version of a vehicle profile package. The notification can be received from the out-of-network vehicle 430, by means of another mobile device or vehicle within the network 110 for example. By receiving the notification, the vehicle and/or the mobile device can discover the out-of-network vehicle 430 as a source of the copy of the updated version of the vehicle profile package or as a potential recipient such a copy, for example. Accordingly, in response to being discovered in such a fashion, the out-of-network vehicle 430 can retrieve and/or share information with the network 110 by means of vehicles and/or mobile devices within the network 110. While illustrated with reference with the out-of-network 430, the disclosed technologies are not limited to such a vehicle and other out-of-network vehicles can be discovered as is described herein.

As an illustration, an out-of-network vehicles (such as fleet, taxi, autonomous vehicles, EV) can permit one or several vehicles in the network 110 to access vehicle information including, for example, predetermined routes, GPS data, destinations, vehicle usual stops, EV stations, favorite and most frequent visited location, and similar At least one of the vehicles(s) in the network 110 can send and/or receive update data via an out-of-network vehicle using different available communication techniques. As such, a vehicle in the network 110 (e.g., a fleet vehicle) seeking updates can receive desirable update data from an out-of-network vehicle at a defined location and a defined time. In one scenario in which the vehicle and the out-of-network vehicle are EVs and within a same city, both such vehicles can exchange update data at an EV station in the city.

With further reference to FIG. 1, the particular arrangement of mobile devices that pertain to the network 110 can change over time. Changes can arise from the mobility of such devices and the ensuing formation and dissolution of short-range communication links between mobile devices and between mobile devices and vehicles within the network 110. In some situations, a group of several mobile devices within the network 110 can be located contemporaneously within a vehicle in the network 110. For instance, such a vehicle can be a bus carrying such a group of devices along a defined route. The mobile devices in the group can collectively retrieve a copy of an update of a vehicle profile package for the bus while traveling in the bus. The mobile devices in the group can further send such a copy to the bus while traveling in the bus. The copy can be retrieved and sent in accordance with aspects described herein. More specifically, simply as an illustration, if such a copy is embodied in a large update file that has to be retrieved from or delivered to the bus, such a group of mobile devices can deliver the copy by parallelizing the retrieval and communication of the copy to the bus. Vehicles and/or other mobile devices in the network 110 can partition the large update file into smaller files. The smaller files can be sent to respective mobile devices in the group, which devices can then send respective smaller files to the bus. By partitioning the large update file into smaller files, the communication of the copy of the updated to the vehicle profile package can be more resilient to a mobile device leaning the group. In such a situation, it can be easier to coordinate one missing or incomplete small file with another mobile device joining the group rather than a missing or incomplete large file that may not be readily available to the bus.

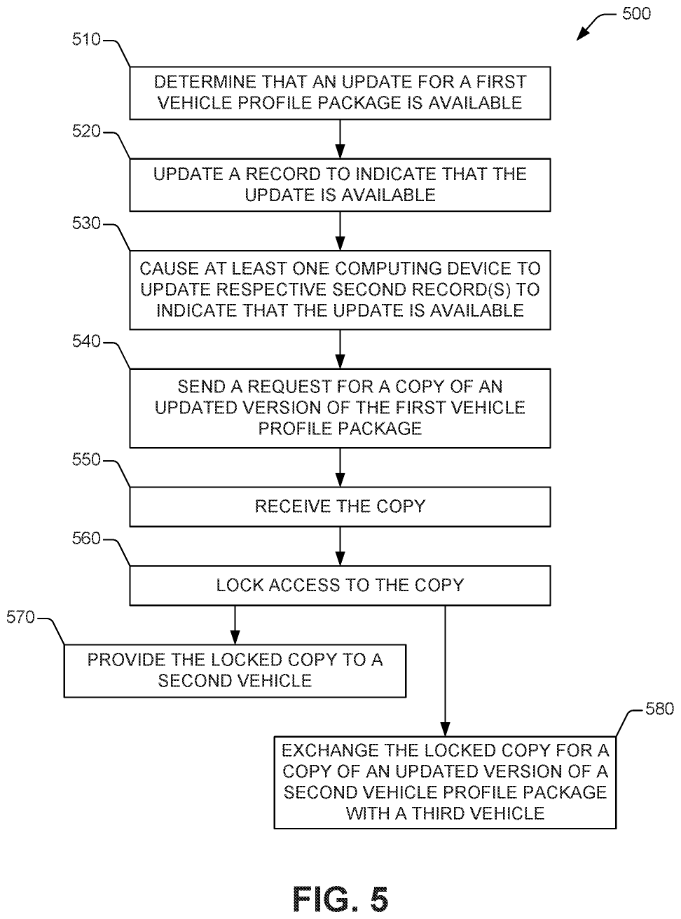

Example of techniques that emerge from the principles of this disclosure and that can be implemented in accordance with this disclosure can be better appreciated with reference to FIGS. 5-7. For purposes of simplicity of explanation, the exemplified methods in FIGS. 5-7 (and other techniques disclosed herein) are presented and described as a series of operations. It is noted, however, that the exemplified method and any other techniques of this disclosure are not limited by the order of operations. Some operations may occur in different order than that which is illustrated and described herein. In addition, or in the alternative, some operations can be performed essentially concurrently with other operations (illustrated or otherwise). Further, not all illustrated operations may be required to implement an exemplified method or technique in accordance with this disclosure. Furthermore, in some embodiments, two or more of the exemplified methods and/or other techniques disclosed herein can be implemented in combination with one another to accomplish one or more elements and/or technical improvements disclosed herein.

Techniques disclosed throughout the subject specification and annexed drawings are capable of being stored on an article of manufacture to facilitate transporting and transferring such methodologies to computers or other types of information processing machines or processing circuitry for execution, and thus implementation by a processor or for storage in a memory device or another type of computer-readable storage device. In one example, one or more processors that perform a method or combination of methods disclosed herein can be utilized to execute programming code instructions retained in a memory device or any computer-readable or machine-readable storage device or non-transitory storage media, to implement one or several of the techniques disclosed herein. The programming code instructions, when executed by the one or more processors can implement or carry out the various operations in the exemplified methods and/or other technique disclosed herein.

The programming code instructions, therefore, provide a computer-executable or machine-executable framework to implement the exemplified methods and/or other techniques disclosed herein. More specifically, yet not exclusively, each block of the flowchart illustrations and/or combinations of blocks in the flowchart illustrations can be implemented by the programming code instructions.

FIG. 5 is a flowchart of an example of a method 500 for supplying updated vehicular profile packages, in accordance with one or more embodiments of this disclosure. A computing apparatus included in a vehicle (e.g., vehicle 120a) can implement, entirely or partially, the example method 500. In some embodiments, the computing apparatus is integrated into the vehicle. In other embodiments, the computing apparatus is functionally coupled to the vehicle. The computing apparatus can embody, or can constitute, the update unit 140 or both the update unit 140 (FIG. 1) and a communication unit in accordance with aspects disclosed herein.

The computing apparatus has a processing device that includes or is functionally coupled to one or more processors, one or more memory devices, other types of computing resources, a combination thereof, or the like. Such processor(s), memory device(s), and computing resource(s), individually or in a particular combination, permit or otherwise facilitate implementing the example method 500. The computing resources can include operating systems (O/Ss); software for configuration and/or control of a virtualized environment; firmware; central processing unit(s) (CPU(s)); graphics processing unit(s) (GPU(s)); tensor processing unit(s) (TPU(s)); virtual memory; disk space; interface(s) (I/O interface devices, programming interface(s) (such as application programming interfaces (APIs), etc.); controller devices(s); power supplies; a combination of the foregoing; or the like. The computing apparatus can include or can be functionally coupled to a communication unit (e.g., the communication unit 158 (FIG. 1)). The communication unit permits the exchange of data, metadata, and/or signaling between the computing apparatus (or a component of the apparatus) and a computing device or an electronic device external to the computing apparatus. Thus, the computing resources available to the computing apparatus also can include downstream communication bandwidth and/or upstream communication bandwidth.

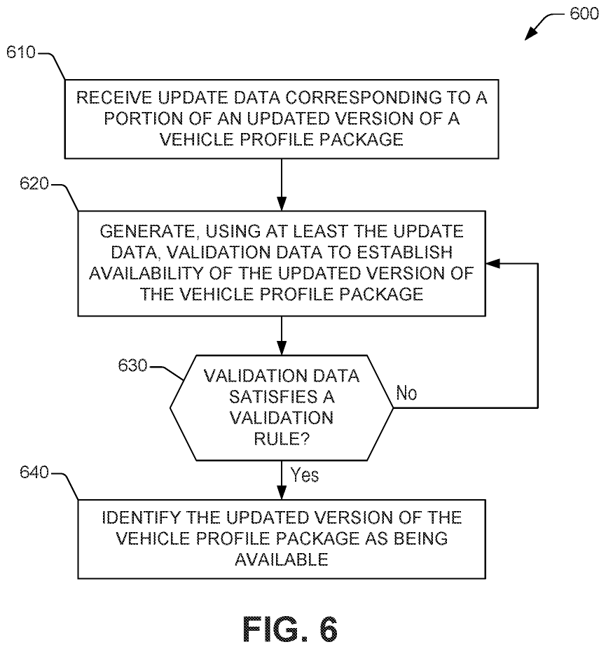

At block 510, the processing device included in the computing apparatus can determine that an update for a first vehicle profile package is available. To that end, in some embodiments, the processing device can implement the example method illustrated in FIG. 6. As mentioned, for the purpose of illustration, a vehicle profile package can include a group of components. The group of components can include a single component or multiple components. Each component in the group of components can include a data or program code, or a combination of both.

At block 520, the processing device can update a record to indicate that the update is available. At block 530, the processing device can cause at least one computing device to update respective second record(s) to indicate that the update is available. Each of the at least one computing device can be located remotely relative to the processing device. At block 540, the processing device can send a request message that a copy of an updated version of the first vehicle profile package be sent to the processing device.

At block 550, the processing device can receive a copy of an updated version of the first vehicle profile package. Such a copy can be received in its entirety from a single source device or in multiple partitions from multiple source devices. The multiple partitions can be received during respective time intervals over a defined period of time.

At block 560, the processing device can lock access to the copy of the updated version of the first vehicle profile package. The processing device can encrypt the copy according to numerous cryptography techniques utilizing private-public key pairs, e.g., symmetric encryption or asymmetric encryption. In one example, a public key can include a unique hash value that results from iteratively operating on data corresponding to a portion of an updated version of the first vehicle profile package. In some instances, locking such a copy can include generating an encryption signature for the copy or a unique code that is only applicable to the copy. The encryption signature and the unique code can be utilized a single time during unlocking (e.g., decrypting) the copy of the updated version of the first vehicle profile package.

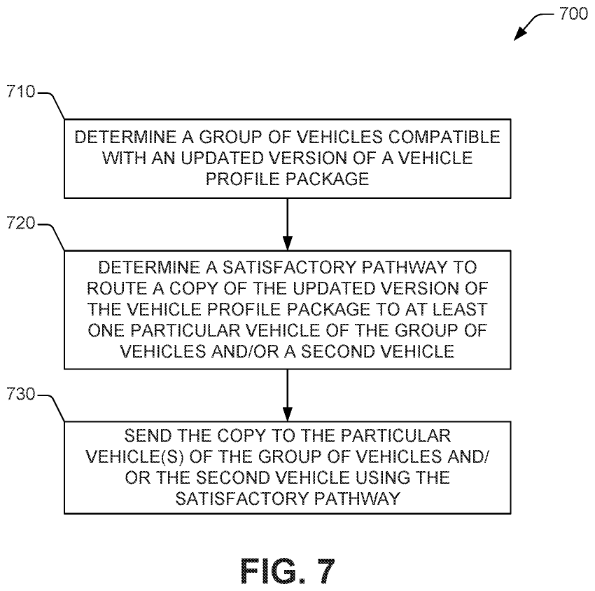

The processing device can then distribute the locked copy in numerous ways. In some instances, at block 570, the processing device can provide the locked copy of the updated version of the first vehicle profile package to a second vehicle. To that end, the processing device can implement the example method illustrated in FIG. 7. In other in instances, at block 580, the processing device can exchange such a locked copy for a copy of an updated version of a second vehicle profile package with the second vehicle. In still other instances, the processing device can implement both block 570 and block 580.

Providing and exchanging the locked copy of the updated version of the first vehicle profile package can include sending the copy to the second vehicle. As such, in some embodiments, the processing device can receive a notification of a reward for sending such a locked copy.

Although the example method 500 includes a locking operation at block 530, the technologies disclosed herein are not limited in that respect. Indeed, in some embodiments, the copy of the updated version of the first vehicle profile package can be provided or exchanged without being previously locked as is described hereinbefore.

FIG. 6 is a flowchart of an example method 600 for determining availability of an update for a vehicle profile package, in accordance with one or more embodiments of this disclosure. The computing apparatus, or a processing device include therein or functionally coupled thereto, that performs the example method 500 also can implement, at least partially, the example method 600. At block 610, the processing device included in the computing apparatus can receive update data corresponding to a portion of an updated version of a vehicle profile package. At block 620, the processing device can generate, using at least the update data, validation data to establish availability of the updated version of the vehicle profile package. Generating the validation data can include generating a hash value, for example. As mentioned, the hash value can be generated according to numerous types of hashing techniques, such as MD5 hashing; SHA-1; SHA-2 and its variants; or similar At block 630, the processing device can determine if the validation data satisfies a validation rule. For the sake of illustration, the validation rule can include a single criterion or a combination of validation criteria as described herein. In response to a negative determination, the example method 600 can continue to block 620 for another iteration of generating validation data. In response to a positive determination, the processing device can identify the updated version of the vehicle profile package as being available at block 640. Thus, the processing device (and the vehicle or mobile device that contains it) can detect the updated version of the vehicle profile package.

FIG. 7 is a flowchart of an example of a method 700 for providing an updated vehicular profile package, in accordance with one or more embodiments of this disclosure. A computing apparatus included in a vehicle (e.g., vehicle 120c) can implement, entirely or partially, the example method 700. In some embodiments, the computing apparatus is integrated into the vehicle. In other embodiments, the computing apparatus is functionally coupled to the vehicle. The computing apparatus can embody, or can constitute, the update unit 140 or both the update unit 140 (FIG. 1) and a communication unit in accordance with aspects disclosed herein. (FIG. 1).

The computing apparatus has a processing device that includes or is functionally coupled to one or more processors, one or more memory devices, other types of computing resources, a combination thereof, or the like. Such processor(s), memory device(s), and computing resource(s), individually or in a particular combination, permit or otherwise facilitate implementing the example method 700. The computing resources can include operating systems (O/Ss); software for configuration and/or control of a virtualized environment; firmware; CPU(s); GPU(s); TPU(s); virtual memory; disk space; interface(s) (I/O interface devices, programming interface(s) (such as application programming interfaces (APIs), etc.); controller devices(s); power supplies; a combination of the foregoing; or the like. The computing apparatus can include or can be functionally coupled to a communication unit (e.g., the communication unit 158 (FIG. 1)). The communication unit permits the exchange of data, metadata, and/or signaling between the computing apparatus (or a component of the apparatus) and a computing device or an electronic device external to the computing apparatus. Thus, the computing resources available to the computing apparatus also can include downstream communication bandwidth and/or upstream communication bandwidth.

At block 710, the processing device can determine a group of vehicles compatible with an updated version of a vehicle profile package. To that end, in one configuration, the processing device can determine that the updated version of the vehicle profile package contains one or more logic that can be applied across the group of vehicles. For instance, such an updated version can be applied to a specific type of pickup truck. Thus, the processing device can determine one or more other types of pickup trucks that are similar to the specific type of pickup truck. Accordingly, the group of vehicles can include pickup trucks of the specific type and pickup trucks of the other type(s).

In another configuration, the processing device can determine that the updated version of the vehicle profile package contains one or more snapshot scenario that can be applied on several vehicles. For example, such an updated version can include data representing a hard acceleration snapshot scenario on a premium vehicle that collects and monitors data from camera, radar, DSRC, and/or other modules. Thus, the processing device can determine one or several other premium high-end vehicles for which the updated version can be applied.

In yet another configuration, the processing device can determine that the updated version of the vehicle profile package contains software applications and/or logic (e.g., TCU, BLIS, DSRC, SYNC, and the like) that can be utilized by various types of vehicles. As such, the group of vehicles includes first vehicles of a first type and second vehicles of a second type, both of which types can utilize the updated version of the vehicle profile package.

At block 720, the processing device can determine a satisfactory communication pathway to route a copy of the updated version of the vehicle profile package to at least one particular vehicle of the group of vehicles or a second vehicle, or both. At block 730, the processing device can send such a copy to the particular vehicle(s) of the group of vehicles or the second vehicle, or both, using the satisfactory pathway.

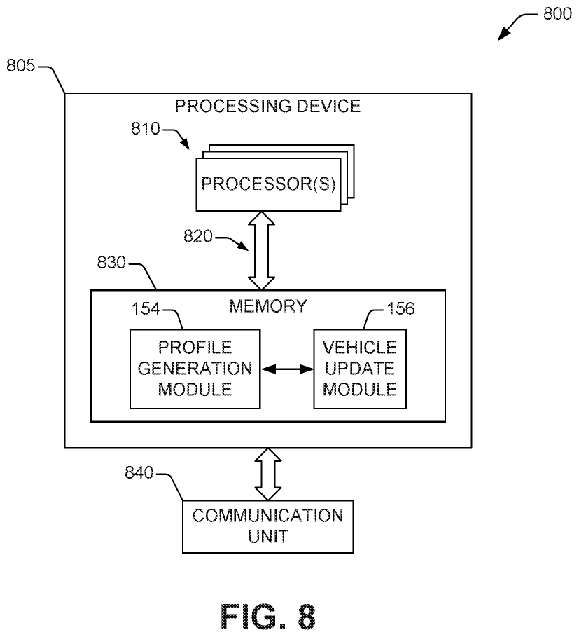

FIG. 8 is a block diagram of an example of a computing apparatus 800 for automated provisioning of an updated for a vehicle profile package, in accordance with one or more embodiments of the disclosure. The computing apparatus 800 can include an update unit 140. Thus, as is illustrated, the apparatus includes a processing device 805 and a communication unit 840. The processing device 805 can embody, or can constitute, the update unit 140. In some embodiments, the processing device 805 and the communication unit 158 can be integrated into a vehicle (e.g., one of the vehicles in the network 110, FIG. 1). In other embodiments, the processing device 805 or the communication unit 840, or both, can be functionally coupled to such a vehicle. In yet other embodiments, the processing device 805 can be integrated into the vehicle and the communication unit 840 can be functionally coupled to the vehicle. In such embodiments, the communication unit 840 can be embodied in the communication unit 158. In other embodiments, the processing device 805 can be integrated into a mobile device (e.g., one of the mobile devices in the network 110, FIG. 1). In such embodiments, the communication unit 840 can be a communication unit integrated into the mobile device. Regardless of the particular embodiment, the communication unit 840 can include one or many antennas and a communication processing device that can permit wireless communication between the vehicle or mobile device that contain the communication unit 840 and an external device. The external device can be, for example, a component integrated into a vehicle or another mobile device. Such a communication processing device can process data according to defined protocols of one or several radio technologies. The data that is processed can be received, by the communication unit 840, in a wireless signal or can be generated by the processing device 805. The radio technologies can include, for example, 3G, Long Term Evolution (LTE), LTE-Advanced, 5G, IEEE 802.11, IEEE 802.16, Bluetooth, ZigBee, near-field communication (NFC), and the like.

The processing device 805 can include one or more processors 810 and one or more memory devices 830 (referred to as memory 830) that include machine-accessible instructions (e.g., computer-readable and/or computer-executable instructions) that can be accessed and executed by at least one of the processor(s) 810. The processor(s) 810 can be embodied in, or can include, for example, a TPU; multiple TPUs; a GPU; multiple GPUs; a CPU; multiple CPUs; an application-specific integrated circuit (ASIC); a microcontroller; a programmable logic controller (PLC); a field programmable gate array (FPGA); a combination thereof; or the like. In embodiments in which the apparatus 800 is included in a vehicle, the processor(s) 810 can be arranged in a single computing device (e.g., an ECU, an in-car infotainment (ICI) system, or the like). In other configurations, the processor(s) 810 can be distributed across two or more computing devices (e.g., multiple ECUs; a combination of an ICI system and one or many ECUs; or the like).

The processor(s) 810 can be functionally coupled to the memory 830 by means of a communication architecture 820. The communication architecture 820 is suitable for the particular arrangement (localized or distributed) of the processor(s) 810. In some embodiments, the communication architecture 820 can include one or many bus architectures, such an Ethernet-based industrial bus, a controller area network (CAN) bus, a Modbus, other types of fieldbus architectures, a combination thereof, or the like.

As is illustrated in FIG. 8, the memory 830 includes the profile generation module 154 and the vehicle update module 156. Machine-accessible instructions embody or otherwise constitute each one of such modules. In some embodiments, the machine-accessible instructions are encoded in the memory 830 and can be arranged in components that can be built (e.g., linked and compiled) and retained in computer-executable form in the memory 830 (as is shown) or in one or more other machine-accessible non-transitory storage media. In other embodiments, the machine-accessible instructions can be assembled as circuitry or other types of hardware components.

At least one of the processor(s) 810 can execute, individually or in combination, the profile generation module 154 and the vehicle update module 156 to cause the processing device 805 to perform functions for automated supply of an update of a vehicle profile package in accordance with this disclosure.

While not illustrated in FIG. 8, the processing device 805 also can include other types of computing resources that can permit or otherwise facilitate the execution of at least one of the profile generation module 154 or the job management module 156. The computing resources can include, for example, several interfaces (such as I/O interfaces, APIs, and/or a wireless communication adapter or another type of wireless communication component). In addition, or as another example, the computing resource(s) can include controller devices(s), power supplies, an O/S, a firmware, a combination thereof, or the like.

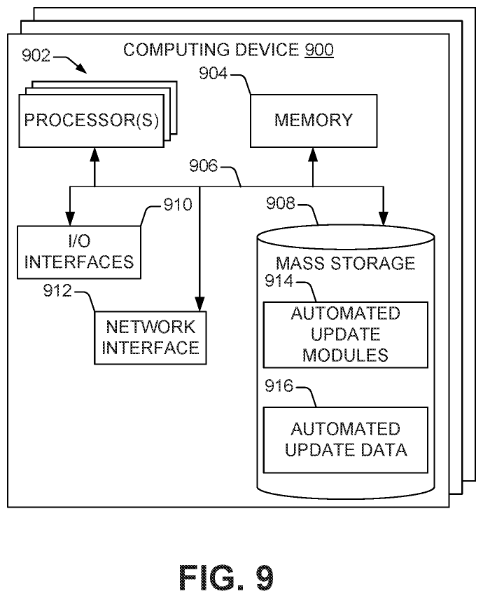

FIG. 9 illustrates a computing environment for the automated provisioning of an update to a vehicle profile package for a vehicle, in accordance with one or more embodiments of this disclosure. The computing environment can include multiple computing devices 900 that can be used in accordance with aspects of this disclosure. A first combination of the computing devices 900 can embody update units (e.g., updated unit 140 in vehicle 120b (FIG. 1)) integrated into vehicles included in a network. A second combination of the computing devices 900 can embody other update units (e.g., update unit 140 in mobile device 130a (FIG. 1)) integrated into mobile devices included in the network. Such a network can embody, or can include, the network 110 (FIG. 1). Each computing device 900 includes at least one processor 902 that executes instructions that are stored in one or more memory devices (referred to as memory 904). The instructions can be, for instance, instructions for implementing functionality described as being carried out by one or more modules and systems disclosed above or instructions for implementing one or more of the methods disclosed above. The processor(s) 902 can be embodied in, for example, a CPU, multiple CPUs, a GPU, multiple GPUs, a TPU, multiple TPUs, a multi-core processor, a combination thereof, and the like. In some embodiments, the processor(s) 902 can be arranged in a single processing device. In other embodiments, the processor(s) 902 can be distributed across two or more processing devices (e.g., multiple CPUs; multiple GPUs; a combination thereof; or the like).

The processor(s) 902 can access the memory 904 by means of a communication architecture 906 (e.g., a system bus). The communication architecture 906 is suitable for the particular arrangement (localized or distributed) and type of the processor(s) 902. In some embodiments, the communication architecture 906 can include one or many bus architectures, such as a memory bus or a memory controller; a peripheral bus; an accelerated graphics port; a processor or local bus; a combination thereof; or the like. As an illustration, such architectures can include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and or the like.

In addition to storing executable instructions, the memory 904 also can retain one or a combination of vehicle profile packages, validation criteria, ledger data, reward data, navigation data, location data, etc.

Each computing device 900 also can include mass storage 908 that is accessible by the processor(s) 902 by means of the communication architecture 906. The mass storage 908 can include machine-accessible instructions (e.g., computer-readable instructions and/or computer-executable instructions). In some embodiments, the machine-accessible instructions are encoded in the mass storage 908 and can be arranged in components that can be built (e.g., linked and compiled) and retained in computer-executable form in the mass storage 908 or in one or more other machine-accessible non-transitory storage media included in the computing device 900. Such components can embody, or can constitute, one or many of the various modules disclosed herein. Such modules are illustrated as automated update modules 914. Accordingly, in some embodiments, the automated update modules 914 can include the profile generation module 154 and the vehicle update module 156. Accordingly, the automated update modules 914 can include the data acquisition component 210, the composition component 220, the update driver component 240, the update mining component 310, the update supply component 320, and, optionally, the reward processing component 360.

Execution of the automated update modules 914, individually or in combination, by at least one of the processor(s) 902, can cause the computing device 900 to provide at least some of the functionality disclosed herein for automated supply of updates to vehicle profile packages. For instance, execution of the automated update modules 914, individually or in combination, can cause the computing device 900 to implement one or more of the techniques disclosed herein.

The mass storage 908 also can retain data that can be utilized to implement the functionality disclosed herein for automated supply of updates to vehicle profile packages or that can result from the implementation of such functionality. Such data are illustrated as automated update data 916 and can include, for example, one or a combination of vehicle profile packages, validation criteria, ledger data, reward data, and the like.

Each computing device 900 also can include one or more input/output interface devices 910 (referred to as I/O interface 910) that can permit or otherwise facilitate external devices to communicate with the computing device 900. For instance, the I/O interface 910 may be used to receive and send data and/or instructions from and to an external computing device. The computing device 900 also includes one or more network interface devices 912 (referred to as network interface(s) 912) that can permit or otherwise facilitate functionally coupling the computing device 900 with one or more external devices. Functionally coupling the computing device 900 to an external device can include establishing a wireline connection or a wireless connection between the computing device 900 and the external device. A combination of at least one of processor(s) 902 and the network interface 912 can embody, or can constitute, the communication unit 840 in some embodiments. In such embodiments, the mass storage 908 can include program code (not depicted) that permit the computing device 900 to communicate wirelessly with an external device according to a particular radio technology protocol.

A combination of the network interface 912, at least one of the I/O interfaces 910, communication procedures (not depicted in FIG. 9) retained in the mass storage 904

As used in this application, the terms “environment,” “system,” “unit,” “module,” “architecture,” “interface,” “component,” and the like refer to a computer-related entity or an entity related to an operational apparatus with one or more defined functionalities. The terms “environment,” “system,” “module,” “component,” “architecture,” “interface,” and “unit,” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (e.g., data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. Still in another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (e.g., data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

As is utilized in this disclosure, the term “processor” can refer to any type of processing circuitry or device. A processor can be implemented as a combination of processing circuitry or computing processing units (such as CPUs, GPUs, or a combination of both). Therefore, for the sake of illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory.

Additionally, or as another example, a processor can refer to an integrated circuit (IC), an ASIC, a digital signal processor (DSP), a FPGA, a PLC, a complex programmable logic device (CPLD), a discrete gate or transistor logic, discrete hardware components, or any combination thereof designed or otherwise configured (e.g., manufactured) to perform the functions described herein.

In some embodiments, processors can utilize nanoscale architectures in order to optimize space usage or enhance the performance of systems, devices, or other electronic equipment in accordance with this disclosure. For instance, a processor can include molecular transistors and/or quantum-dot based transistors, switches, and gates.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Memory components or memory devices disclosed herein can be embodied in either volatile memory or non-volatile memory or can include both volatile and non-volatile memory. In addition, the memory components or memory devices can be removable or non-removable, and/or internal or external to a computing device or component. Examples of various types of non-transitory storage media can include hard-disc drives, zip drives, CD-ROMs, digital versatile disks (DVDs) or other optical storage, magnetic cassettes, magnetic tape, magnetic disk storage or other magnetic storage devices, flash memory cards or other types of memory cards, cartridges, or any other non-transitory media suitable to retain the desired information and which can be accessed by a computing device.

As an illustration, non-volatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory devices or memories of the operational or computational environments described herein are intended to include one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The flowchart and block diagrams in the figures illustrate the architecture, functionality, and operation of possible implementations of examples of systems, methods, and computer program products according to various embodiments of the present disclosure. In this regard, each block in the flowchart or block diagrams may represent a module, segment, or portion of instructions, which includes one or more machine- or computer-executable instructions for implementing the specified operations. It is noted that each block of the block diagrams and/or flowchart illustration, and combinations of blocks in the block diagrams and/or flowchart illustration, can be implemented by special purpose hardware-based systems that perform the specified functions or operations or carry out combinations of special purpose hardware and computer instructions.

Computer-readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable non-transitory storage medium within the respective computing/processing device.

What has been described herein in the present specification and annexed drawings includes examples of systems, devices, techniques, and computer program products that, individually and in combination, permit the automated provision of an update for a vehicle profile package. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

1. A method, comprising:
determining, by a computing apparatus comprising at least one processor, that an update for a first vehicle profile package is available, wherein the first vehicle profile package comprises a group of components, and wherein a first component of the group of components comprises at least one of data or program code, the data defining a parameter of operation of a vehicle and the program code providing one or more of a procedure to analyze the operation of the vehicle or a defined functionality of the vehicle, wherein determining that the update for the first vehicle profile package is available comprises:
receiving update data corresponding to a portion of an updated version of the first vehicle profile package;
generating, using at least the update data, validation data to establish availability of the updated version of the first vehicle profile package, wherein the validation data comprises a hash value, the hash value comprising a first set of characters and a second set of characters; and
determining, based on determining that the first set of characters of the hash value satisfies a validation rule and the second set of characters of the hash value fails to satisfy the validation rule, that the updated version of the first vehicle profile package is available;
receiving, by the computing apparatus, a copy of the updated version of the first vehicle profile package;
locking, by the computing apparatus, access to the copy of the updated version of the first vehicle profile package; and
providing, by the computing apparatus, the locked copy of the updated version of the first vehicle profile package to a second vehicle.

2. The method of claim 1, wherein the locking comprises encrypting the copy using an encryption key that includes the hash value.

3. The method of claim 1, further comprising exchanging the locked copy for a copy of an updated version of a second vehicle profile package with the second vehicle.

4. The method of claim 3, further comprising receiving a notification of a reward for sending the locked copy.

5. The method of claim 1, wherein the providing comprises determining that the second vehicle is compatible with the updated version of the first vehicle profile package.

6. The method of claim 5, wherein the providing further comprises,
determining a satisfactory communication pathway to route the copy of the updated version of the first vehicle profile package to the second vehicle; and
sending the copy to the second vehicle using the satisfactory communication pathway.

7. The method of claim 5, wherein the providing further comprises sending a recommendation message for the updated version of the first vehicle profile package to the vehicle.

8. A vehicle, comprising:
an apparatus comprising,
at least one processor; and
at least one memory device functionally coupled to the at least one processor, the at least one memory device having instructions encoded thereon that, in response to execution by the at least one processor, cause the apparatus to perform or facilitate operations comprising:
determining that an update for a first vehicle profile package is available, wherein the first vehicle profile package comprises a group of components, and wherein a first component of the group of components comprises at least one of data or program code, the data defining a parameter of operation of the vehicle and the program code providing one or more of a procedure to analyze the operation of the vehicle or a defined functionality of the vehicle, wherein the determining comprises:
receiving update data corresponding to a portion of an updated version of the first vehicle profile package;
generating, using at least the update data, validation data to establish availability of the updated version of the first vehicle profile package, wherein the validation data comprises a hash value, the hash value comprising a first set of characters and a second set of characters; and
determining, based on determining that the first set of characters of the hash value satisfies a validation rule and the second set of characters of the hash value fails to satisfy the validation rule, that the updated version of the first vehicle profile package is available;
receiving a copy of an updated version of the first vehicle profile package;
locking access to the copy of the updated version of the first vehicle profile package; and
providing the locked copy of the updated version of the first vehicle profile package to a second vehicle.

9. (canceled)

10. The vehicle of claim 8, wherein the operations further comprise exchanging the locked copy for a copy of an updated version of a second vehicle profile package with the second vehicle.

11. The vehicle of claim 10, wherein the operations further comprise receiving a notification of a reward for sending the locked copy.

12. The vehicle of claim 8, wherein the providing comprises determining that the second vehicle is compatible with the updated version of the first vehicle profile package.

13. The vehicle of claim 12, wherein the providing further comprises,
determining a satisfactory communication pathway to route the copy of the updated version of the first vehicle profile package to the second vehicle; and
sending the copy to the second vehicle using the satisfactory communication pathway.

14. The vehicle of claim 12, wherein the providing further comprises sending a recommendation message for the updated version of the first vehicle profile package to the vehicle.

15. An apparatus, comprising:
at least one processor that executes instructions to cause the apparatus to perform or facilitate operations comprising,
determining that an update for a first vehicle profile package is available, wherein the first vehicle profile package comprises a group of components, and wherein a first component of the group of components comprises at least one of data or program code, the data defining a parameter of operation of a vehicle and the program code providing one or more of a procedure to analyze the operation of the vehicle or a defined functionality of the vehicle wherein determining that the update for the first vehicle profile package is available comprises:
receiving update data corresponding to a portion of an updated version of the first vehicle profile package;
generating, using at least the update data, validation data to establish availability of the updated version of the first vehicle profile package, wherein the validation data comprises a hash value, the hash value comprising a first set of characters and a second set of characters; and
determining, based on determining that the first set of characters of the hash value satisfies a validation rule and the second set of characters of the hash value fails to satisfy the validation rule, that the updated version of the first vehicle profile package is available;
receiving a copy of an updated version of the first vehicle profile package;
locking access to the copy of the updated version of the first vehicle profile package; and
providing the locked copy of the updated version of the first vehicle profile package to a second vehicle.

16. The apparatus of claim 15, wherein the operations further comprise exchanging the locked copy for a copy of an updated version of a second vehicle profile package with the second vehicle.

17. The apparatus of claim 16, wherein the operations further comprise receiving a notification of a reward for sending the locked copy.

18. The apparatus of claim 15, wherein the providing comprises determining that the second vehicle is compatible with the updated version of the first vehicle profile package.

19. The apparatus of claim 18, wherein the providing further comprises,
determining a satisfactory communication pathway to route the copy of the updated version of the first vehicle profile package to the second vehicle; and
sending the copy to the second vehicle using the satisfactory communication pathway.

20. The apparatus of claim 18, wherein the providing further comprises sending a recommendation message for the updated version of the first vehicle profile package to the vehicle.
